(19) United States
(12) Patent Application Publication
(10) Pub. No.: US 2021/0137183 A1
(43) Pub. Date: May 13, 2021

(54) LOOM FOR USE IN AN ITEM OF CLOTHING

(71) Applicant: Wearable Technology Limited, Leicester (GB)

(72) Inventor: Neil John CARTER, Nuneaton (GB)

(21) Appl. No.: 17/097,029

(22) Filed: Nov. 13, 2020

(30) Foreign Application Priority Data
Nov. 13, 2019 (GB) 1916556.2

(51) Int. Cl. A41D 13/01; A41D 1/00; G08B 5/00; H01B 11/02; F21V 33/00

(52) U.S. Cl. CPC A41D 13/01; A41D 1/005; F21Y 2115/10; H01B 11/02; F21V 33/0008; G08B 5/004

(57) ABSTRACT

A loom is shown for use in an item of clothing for use in hazardous environments, wherein said item of clothing includes light emitting devices and connectors for receiving peripheral devices. A first conductor 501 and a second conductor 502 are twisted together to form a first twisted pair 503; a third conductor 513 and a fourth conductor 514 are twisted together to form a second twisted pair 515. A woven material 516 surrounds the first twisted pair and the second twisted pair. Stitches 517 are placed between the first twisted pair and the second twisted pair to form a first conduit 521 for the first twisted pair and a second conduit 522 for the second twisted pair.

### CROSS REFERENCE TO RELATED APPLICATIONS

This application claims priority from United Kingdom patent application number 1916556.2, filed on Nov. 13, 2019, the whole contents of which are incorporated herein by reference.

### BACKGROUND OF THE INVENTION

The present invention relates to a loom for use in items of clothing for use in hazardous environments.

It is known to provide hazard sensors on items of clothing, typically for detecting dangerous gases, radiation or excessive sound levels etc. It is also known to provide communication devices and personal area networks within items of clothing, which facilitate the inclusion of warning devices and allow communication back to base stations etc.

Within the item of clothing, communication between devices may be facilitated by the provision of a loom. In addition to conveying data, the loom may also provide power. However, although many devices may be removed prior to washing, the loom remains permanently attached to the garment itself. Consequently, problems arise when garments undergo washing cycles. Typically, washing cycles of this type may be performed at relatively high temperatures, usually above eighty-degrees Celsius. This may result in loom failure, which will then require the garment to be discarded and replaced.

### BRIEF SUMMARY OF THE INVENTION

According to a first aspect of the present invention, there is provided a loom for use in an item of clothing for use in hazardous environments, wherein said item of clothing includes light-emitting devices and connectors for receiving peripheral devices, comprising: a first conductor and a second conductor twisted together to form a first twisted pair; a third conductor and a fourth conductor twisted together to form a second twisted pair; a woven material surrounding said first twisted pair and said second twisted pair; and stitches between said first twisted pair and said second twisted pair to form a first conduit for said first twisted pair and a second conduit for said second twisted pair.

In an embodiment, the conductor has an electrically conducting core surrounded by a silicone rubber insulator, to facilitate the washing of an item of clothing at temperatures above eighty-degrees Celsius. Furthermore, in an embodiment, the woven material has a weave sufficiently tight to prevent the conductors from penetrating the weave. The weave may also include conductive threads.

According to a second aspect of the present invention, there is provided a method of weaving a loom for inclusion within an item of clothing, comprising the steps of: receiving a first twisted pair formed from a first conductor and a second conductor; receiving a second twisted pair formed from a third conductor and fourth conductor; weaving a material from warp threads and weft threads around said twisted pairs; and stitching between said first twisted pair and said second twisted pair to form a first conduit for said first twisted pair and a second conduit for said second twisted pair.

In an embodiment, the receiving steps, the weaving step and a stitching step are performed during a single pass weaving operation.

### BRIEF DESCRIPTION OF THE SEVERAL VIEWS OF THE DRAWINGS

FIG. 1 shows operatives working in a hazardous environment;

FIG. 2 shows a schematic representation of the apparatus identified in FIG. 1;

FIG. 3 shows a schematic representation of a weaving machine;

FIG. 4 details an example of a weaving machine of the type identified in FIG. 3;

FIG. 5 shows a portion of the loom identified in FIG. 2;

FIG. 6 shows a cross-section of the loom portion identified in FIG. 5;

FIG. 7 shows an example of a peripheral device connector;

FIG. 8 shows a first circuit board for receiving the peripheral device connector identified in FIG. 7;

FIG. 9 shows the connection of a peripheral device connector to loom portions;

FIG. 10 shows an example of a loom connector;

FIG. 11 shows an interface circuit for interfacing between the loom connector of FIG. 10 and a hazard sensing device;

FIG. 12 shows the rear of the circuit identified in FIG. 11;

FIG. 13 shows an alternative item of clothing for receiving a control unit;

FIG. 14 shows the rear of a control unit; and

FIG. 15 shows the control unit identified in FIG. 14 attached to the item of clothing identified in FIG. 13.

### DETAILED DESCRIPTION OF EMBODIMENTS OF THE INVENTION

Embodiments of the invention will be described, by way of example only, with reference to the accompanying drawings. The detailed embodiments show the best mode known to the inventor and provide support for the invention as claimed. However, they are only exemplary and should not be used to interpret or limit the scope of the claims. Their purpose is to provide a teaching to those skilled in the art.

Components and processes distinguished by ordinal phrases such as “first” and “second” do not necessarily define an order or ranking of any sort.

### FIG. 1

Operatives are shown in FIG. 1 working in a hazardous environment. Each operative wears an item of clothing, such as a jacket 101, that includes a control unit and a hazard sensor 102. In the example shown in FIG. 1, the control unit is retained within an internal pocket. The item of clothing includes a loom of conducting cables connected to a plurality of peripheral device connectors, for data transmission.

The item of clothing in FIG. 1 is a jacket but other items of clothing may be deployed, usually of a type worn on the upper torso. Thus, the item of clothing may take the form of a vest or a tabard etc.

In this embodiment, the item of clothing also includes light-emitting devices 103 connected to the loom and configured to be illuminated in response to power and data received from the control unit, as described in U.S. Pat. No. 10,161,611 assigned to the present applicant. The loom connects the light emitting devices and peripheral device connectors to a control unit. In the embodiment, the loom consists of a first conductor and a second conductor twisted together to form a first twisted pair. In addition, a third conductor and a fourth conductor are twisted together to form a second twisted pair and a woven material surrounds the first twisted pair and the second twisted pair. In addition, stitches are provided between the first twisted pair and the second twisted pair to form a first conduit for the first twisted pair and a second conduit for the second twisted pair.

in an embodiment, the control unit is configured to convey electrical energy over the first twisted pair and a data signals over the second twisted pair to the light-emitting devices and peripheral devices. The light-emitting devices may be light-emitting diodes configured to emit colored light and the color of the light is controlled in response to receiving data signals from the control unit.

Many types of hazard sensor may be deployed, with the many sensors of this type becoming available at substantially reduced costs by the deployment of micro-electro-mechanical systems (MEMS). This facilitates the deployment of substantially more detectors of this type within a particular environment.

Previously, specialist equipment may have been carried by a single operative who was then responsible for periodically checking hazard levels. However, it is becoming increasingly evident that with personal area networks and local area networks, it is possible to collect data from a much larger number of operatives, possibly all operatives, working within an environment. The individual sensors themselves may be less sensitive but the collection of substantially larger volumes of data in real-time enhances the overall effectiveness of hazard detection

Hazard sensors are available for producing data in response to detecting hazards that non-exclusively include gas, radiation, dust particles, sound, proximity to vehicles and proximity to other operatives.

In addition to the hazard detecting sensor 102, the apparatus of FIG. 1 also includes a non-hazard detecting peripheral device 104 that, non-exclusively, may be a radio device, a power storage device, a single image camera or a video camera. The functionality of device 104 may also change when the device is disconnected, as described in U.S. Pat. No. 10,311,712, assigned to the present applicant.

### FIG. 2

A schematic representation of the apparatus identified in FIG. 1 is shown in FIG. 2. The item of clothing 101 includes a loom 201 of conducting cables. These conducting cables are connected to peripheral device connectors, including a first peripheral device connector 211 and a second peripheral device connector 212. Data transmission occurs over the loom in accordance with a loom protocol. The loom protocol is based around established I-squared-C protocols and facilitates the generation of data for activating LED devices, such as devices 103. A control unit 213 is connected to the loom 201 by means of a loom connector 214 that attaches to peripheral device connector 212. A hazard sensor 215 has a hazard sensing device 216, a loom connector 217 and an interface circuit 218.

In FIG. 2, the loom 201 is shown schematically as four wires. However, as described with reference to FIG. 5, these actually consist of two twisted pairs.

### FIG. 3

A schematic representation of a weaving machine 301 is shown in FIG. 3. The weaving machine 301 receives a first twisted pair 311 formed from a first conductor and a second conductor. In addition, the weaving machine 301 receives a second twisted pair 312, formed from a third conductor and a fourth conductor. Warp threads 313 are received along with weft threads 314 and weft threads 315. In an embodiment, the first weft threads 314 are nonconductive and the second weft threads 315 are electrically conductive. Thus, in an embodiment, weaving is performed using electrically conductive threads which, in an embodiment, are included in sufficient quantity to make the woven material electrically conductive. In this embodiment, the electrically conductive material is included in the weft threads 315 but, in an alternative embodiment, electrically conductive threads could be included in the warp threads 313.

Material from the warp threads 313 and the weft threads 314/315 are woven around the twisted pairs 311/312. In addition, stitching, as described with reference to FIG. 5, is placed between the first twisted pair and the second pair to from a first conduit for the first twisted pair and a second conduit for the second twist pair. In the embodiment of FIG. 3, these steps (of receiving, weaving and stitching) are performed during a single-pass weaving operation.

In an embodiment, the first conductor is pre-twisted with the second conductor to form the first twisted pair and, similarly, the third conductor is pre-twisted with the fourth conductor to form the second twisted pair.

The resulting loom 201, in an embodiment, is loaded onto a reel 316 after the weaving operation. Thus, continuous production occurs until source reels need replacement. Loom sections are subsequently cut from reel 316 for inclusion within garments.

### FIG. 4

An example of a weaving machine 301 is detailed in FIG. 4. Warp threads 313 are received substantially vertically and manipulated, to facilitate the inclusion of weft threads 314. The resulting loom assembly 201 exits the machine vertically, to be retained on real 316 as previously described.

### FIG. 5

A portion of loom 201 is shown in FIG. 5. A first conductor 501 and a second conductor 502 are twisted together to form a first twisted pair 503. In addition, a third conductor 513 and a fourth conductor 514 form a second twisted pair 515.

A woven material 516 surrounds the first twisted pair 503 and the second twisted pair 515. A line of stitching 517 is applied between the first twisted pair 503 and the second twisted pair 515. This ensures that the two twisted pairs are separated and retained within their own respective conduits.

In an embodiment, the weaving operation produces a weave that is sufficiently tight to prevent the conductors from penetrating the weave. Machines for achieving this level of tightness are available, given that fabric constructions exist that contain reinforcement metal. In addition, the inclusion of the stitching 517 results in the creation of a first conduit 521 and a second conduit 522. The first twisted pair 503 is therefore retained in the first conduit 521 and the second twisted pair 515 is retained within a second conduit 522. In this way, it is difficult for the twisted pairs to form loops which may then result in cable failure. The nature of the twists is such as to impart mechanical stability upon the wires, significantly enhancing their resilience to movement when the item of clothing is being worn.

It should also be appreciated that the twisted pairs also improve electrical characteristics in that induced noise tends to be cancelled out. Thus, the twisting of the conductors provides two significant benefits in that it enhances mechanical stability and reduces electrical noise.

### FIG. 6

A cross-section of the loom portion 201 is shown in FIG. 6. The first twisted pair is held within the first conduit 521, with the second twisted pair being retained within the second conduit 522.

Each conductor, such as the first conductor 501, includes a conducting inner core 603 and a surrounding insulator 604. In an embodiment, the surrounding insulator 604 is formed from a silicone rubber that is capable of being washed at relatively high temperatures, typically above 80° C. The woven material 516 allows a degree of flexibility to facilitate deployment of the loom within an item of clothing. However, it is also resilient to ensure that the cables contained therein cannot penetrate the outer surface of the loom. Furthermore, it is difficult for the cables to form loops, which could create positions of weakness and failure.

In this embodiment, the fabric material 516 includes electrically conductive threads 611, to facilitate operation within environments that may include explosive gases.

The woven material is brought together at each end to form a first securing tab 621 and a second securing tab 622. These securing tabs allow the loom to be secured, possibly by stitching, to the item of clothing. One of the securing tabs may be color coded to distinguish the two twisted pairs. This ensures that a twisted pair for carrying data can be distinguished from a twisted pair for carrying power.

### FIG. 7

Peripheral device connector 211 is shown in FIG. 7. The peripheral device connector is configured to provide a mechanically-detachable electric interface for equipment that is supported on the external surface of an item of clothing. The connector may be a freedom LP360 type device available from Fischer Connectors of Saint-Prex Switzerland.

The connector 211 includes a rigid component 701 that is configured to extend externally through an orifice defined in an item of clothing. In addition, the connector 701 also includes an internal electrical interface portion 702.

### FIG. 8

A first circuit board 801 is shown in FIG. 8, for supporting a peripheral device connector of the type described with respect to FIG. 7. The first circuit board 801 includes first contacts 811 that are attachable to the internal electrical interface portion 702 of the peripheral device connector. The first contacts 811 are electrically connected to a first set of loom connectors 821 and a second set of loom connectors 822.

### FIG. 9

The first contacts 811 of a first circuit board 801 receive the electrical interface wires 702 of a peripheral device connector. Loom wires of a first loom portion are soldered to the first contacts 821, with the similar loom wires of a second loom portion being soldered to the second contacts 822.

The combination of the first circuit board, a peripheral device connector, an end of a first loom portion and an end of a second loom portion are over moulded in rubber to provide a rubber cover 901. Cover 901 includes a first strain relief portion 902 and a second strain relief portion 903. The cover 901 also includes a first side flange 904 and a second side flange 905, to facilitate attachment of the cover to a garment, as described in GB 2569816 assigned to the present applicant.

The rigid component 701 of the peripheral device connector 211 extends through an orifice 906 in the rubber cover. In an embodiment, an outer cover 907 is also provided that includes a similar orifice 908. The peripheral device connector presents a circular surface 911 which, when deployed, lies substantially parallel with the outer surface of the garment. The circular surface includes a plurality of concentric electrical connectors to provide electrical connection to loom connectors, such as the type described with reference to FIG. 8, each attached to a peripheral device.

### FIG. 10

Loom connector 217 is shown in FIG. 10, configured to mechanically attach to a peripheral device connector, such as peripheral device connector 211. In addition to providing a mechanical attachment, an electrical interface is also defined by a first electrical contact 1001, a second electrical contact 1002, a third electrical contact 1003, and a fourth electrical contact 1004. These electrical contacts 1001 to 1004 are arranged so as to make contact with a respective circular electrode defined on circular surface 911. Thus, in this way, it is possible for a loom connector to rotate relatively to a peripheral device connector while still retaining electrical contact.

A ribbon cable 1011 connects electrical contacts 801 to 804 to a zero-insertion-force (ZIF) plug 1012. This in turn allows the loom connector 217 to be electrically connected to the interface circuit 218.

### FIG. 11

Interface circuit 218 is shown in FIG. 11. A microprocessor 1101 has built-in interfaces, including an I-squared-C interface that interfaces with the garment loom, as described with reference to FIG. 10. The microprocessor 1101 also has a second, I-squared-C interface and an SPI interface (serial peripheral interface) also known as a four-wire serial bus. In addition, the microprocessor provides a universal asynchronous receiver/transmitter interface (UART) allowing it to receive serial data streams following many established protocols.

An input/output port is provided for interfacing with sensor devices that raise a signal when an alert is identified. The microprocessor 1101 is also provided with an analog-to-digital converter, allowing the processor to interface with analog outputs. Thus, in this way, it is possible for any available output from a sensor to be translated by the microprocessor 1101 and then put out onto the garment bus in accordance with the loom protocol.

The interface circuit 218 also allows power to be passed from the loom to the sensor device. Protection circuitry on the device may also receive power in this way.

A first hole 1111 and a second hole 1112 align with earth pins on the loom connector 217 to provide a secure connection to the loom connector. Electrical connection is then made by means of the ZIF connector described with reference to FIG. 10.

The upper surface of the interface circuit shown in FIG. 9 includes a plurality of solder pads 1115. Serial interfaces from the microprocessor 1101 are connected to respective solder pads 1115. During the assembly of the sensor 215, appropriate connections are made between the sensing device 216 and the appropriate solder pads 1115.

The interface circuit 218 shown in FIG. 9 includes a board extension portion 1121. The board extension portion 1121 includes a micro USB socket 1122 that is used to transfer executable instructions and data to the microprocessor 1101. After being programmed in this way, the board extension 1121 is snapped off, thereby reducing the overall size of the interface circuit to facilitate inclusion within the interface assembly 215.

### FIG. 12

The underside of interface circuit 218 is shown in FIG. 12. The board extension has been removed. A ZIF socket 1201 receives the ZIF plug 1012, whereafter the underside of the interface circuit is physically secured to the loom connector 217.

### FIG. 13

As described with reference to FIG. 1, it is possible for a control unit (also referred to as a hub) to be retained within an internal pocket of a jacket, such as jacket 101, thereby providing a degree of mechanical protection. Alternatively, and particularly if regular monitoring is required, it is possible for a control unit to be mounted externally.

An item of clothing in the form of a vest 1301 is shown in FIG. 13. The vest is constructed from fluorescent material 1302 with light reflective strips 1303. A peripheral device connector 1304 extends from conductive strip 1303, with the twisted pairs of the wire loom 211 being retained behind the light reflective strip 1303. In this example, a subassembly 1305 of light-emitting diodes 1306 is also attached to the light reflective strip 1304 and electrically connected to the loom 201.

### FIG. 14

An example of a control unit 1401 is shown in FIG. 14. The rear surface of the control unit 1401 is shown in FIG. 14, exposing a loom connector 1411.

### FIG. 15

To secure the control unit shown in FIG. 14, the loom connector 1411 is attached to the peripheral device connector 1304, as shown in FIG. 15. In this configuration, an operative can activate the control unit by depressing a large control button 1501. In addition, an operative can view output indications provided by light-emitting diodes retained within a transparent enclosure 1502.

The invention claimed is:

1. A loom for use in an item of clothing for use in hazardous environments, wherein said item of clothing comprises light-emitting devices and connectors for receiving peripheral devices, comprising:
a first conductor and a second conductor twisted together to form a first twisted pair;
a third conductor and a fourth conductor twisted together to form a second twisted pair;
a woven material surrounding said first twisted pair and said second twisted pair; and
stitches between said first twisted pair and said second twisted pair to form a first conduit for said first twisted pair and a second conduit for said second twisted pair.

2. The loom of claim 1, wherein said item of clothing is non-exclusively selected from a list comprising jackets and vests.

3. The loom of claim 1, wherein said item of clothing comprises fluorescent material and light-reflective strips.

4. The loom of claim 1, further comprising a control unit configured to convey electrical energy over said first twisted pair and a data signal over said second twisted pair to said light-emitting devices, wherein said light-emitting devices are light-emitting diodes configured to emit colored light and a color of said colored light is controlled in response to receiving said data signal.

5. The loom of claim 1, wherein each of said first conductor, said second conductor, said third conductor, and said fourth conductor has an electrically-conducting core surrounded by a silicone rubber insulator to facilitate washing of said item of clothing at temperatures above eighty degrees Celsius.

6. The loom of claim 1, wherein said woven material has a weave sufficiently tight to prevent said first conductor, said second conductor, said third conductor, and said fourth conductor from penetrating said weave.

7. The loom of claim 1, wherein said woven material comprises electrically conductive threads.

8. The loom of claim 7, wherein said woven material comprises a sufficient quantity of said electrically conductive threads so as to make said woven material electrically conductive.

9. The loom of claim 7, wherein said woven material is formed from a warp and a weft and said electrically conductive threads are comprised in said weft.

10. The loom of claim 1, wherein said woven material comprises at least one securing tab extending from at least one of said first conduit or said second conduit to facilitate attachment of said loom to said item of clothing.

11. A method of weaving a loom for inclusion within an item of clothing, comprising the steps of:
receiving a first twisted pair formed from a first conductor and a second conductor;
receiving a second twisted pair formed from a third conductor and a fourth conductor;
weaving a material from warp threads and weft threads around said first twisted pair and said second twisted pair; and
stitching between said first twisted pair and said second twisted pair to form a first conduit for said first twisted pair and a second conduit for said second twisted pair.

12. The method of claim 11, wherein said receiving steps, said weaving step, and said stitching step are performed during a single-pass weaving operation.

13. The method of claim 12, further comprising the steps of:
pre-twisting said first conductor with said second conductor to form said first twisted pair; and
pre-twisting said third conductor with said fourth conductor to form said second twisted pair.

14. The method of claim 11, further comprising the step of loading said loom onto a reel after said receiving steps, said weaving step, and said stitching step are complete.

15. The method of claim 11, wherein said receiving steps comprise receiving said first conductor, said second conductor, said third conductor, and said fourth conductor that each has an electrically-conducting core surrounded by a silicone rubber insulator, wherein said silicone rubber insulator is configured to encounter temperatures above eighty degrees Celsius.

16. The method of claim 11, wherein said weaving step comprises performing a sufficiently tight weaving operation to prevent said first conductor, said second conductor, said third conductor, and said fourth conductor from penetrating a weave formed during said weaving step.

17. The method of claim 11, wherein said material comprises electrically conductive threads.

18. The method of claim 17, wherein a sufficient quantity of said electrically conductive threads are used to make a woven material formed from said weaving step electrically conductive.

19. The method of claim 17, wherein said electrically conductive threads are comprised in said weft threads.

20. The method of claim 11, wherein said weaving step comprises weaving at least one securing tab extending from at least one of said first conduit or said second conduit.
